(19) United States
(12) Patent Application Publication
(10) Pub. No.: US 2020/0088309 A1
(43) Pub. Date: Mar. 19, 2020

(54) SPOOL VALVE UNIT AND VALVE DEVICE

(71) Applicant: DENSO CORPORATION, Kariya-city (JP)

(72) Inventors: Masaaki KONO, Nisshin-city (JP); Takahiro TOMEDA, Nisshin-city (JP); Fukuo KITAGAWA, Nisshin-city (JP); Yusuke KIMURA, Nisshin-city (JP); Tadayoshi NAKASE, Nisshin-city (JP); Shinichi KONDO, Kariya-city (JP); Kazuhiro SASAO, Kariya-city (JP); Masato ARAI, Kariya-city (JP); Motoyoshi ANDO, Kariya-city (JP)

(21) Appl. No.: 16/569,965

(22) Filed: Sep. 13, 2019

(30) Foreign Application Priority Data
Sep. 19, 2018 (JP) 2018-174930

(51) Int. Cl. F16K 11/07; F16K 27/04; F16F 1/04; F16K 31/56

(52) U.S. Cl. CPC F16K 11/0712; F16K 31/566; F16F 1/047; F16K 27/048

(57) ABSTRACT

A spool valve unit includes a sleeve member having a high-pressure port and a low-pressure port, a spool member movably accommodated in the sleeve member in an axial direction, and a spring member for biasing the spool member in a first axial direction. The spool valve unit produces an intermediate fluid pressure to be outputted to an outside of the spool valve unit, when electromagnetic force is applied to the spool member so that the spool member is moved at a high speed between the high-pressure port and the low-pressure port. The spring member is composed of a non-linear spring, a biasing force of which is non-linearly changed with respect to a displacement of the spool member.

### CROSS REFERENCE TO RELATED APPLICATION

This application is based on Japanese Patent Application No. 2018-174930 filed on Sep. 19, 2018, the disclosure of which is incorporated herein by reference.

### FIELD OF TECHNOLOGY

The present disclosure relates to a spool valve unit and a valve device using the same.

### BACKGROUND

A spool valve unit is known in the art, according to which a control force is applied to a spool member in order to rapidly move the spool member between a high-pressure port and a low-pressure port and thereby to generate an intermediate fluid pressure between a pump pressure and a drain pressure.

When the spool member is reciprocated with a frequency, which includes a resonance frequency for the spool member and a spring member for biasing the spool member, to generate the intermediate fluid pressure in the spool valve unit for a fluid pressure control, the spool member and the spring member may resonate with each other and thereby fluid pressure of working fluid may be oscillated. Then, it is difficult to control the spool valve unit to stably generate a desired fluid pressure.

According to one of prior arts, an orifice is provided in a fluid passage communicated to a spring chamber to form a damping mechanism and thereby to suppress generation of oscillation of fluid pressure. Since the damping mechanism limits a rapid movement of a spool member and prevents a rapid control of the fluid pressure, there is a barrier for such a spool valve unit which provides a rapid response.

### SUMMARY OF THE DISCLOSURE

The present disclosure is made in view of the above problem. It is an object of the present disclosure to provide a spool valve unit, according to which controllability for resisting oscillation of fluid pressure can be improved without decreasing performance of rapid fluid pressure control.

According to a feature of the present disclosure, a spool valve unit includes a sleeve member having a high-pressure port and a low-pressure port, a spool member movably accommodated in the sleeve member in an axial direction, and a spring member for biasing the spool member in a first axial direction. The spool valve unit produces an intermediate fluid pressure to be outputted to an outside of the spool valve unit, when electromagnetic force is applied to the spool member so that the spool member is moved at a high speed between the high-pressure port and the low-pressure port. The spring member is composed of a non-linear spring, a biasing force of which is non-linearly changed with respect to a displacement of the spool member.

A spring constant of the non-linear spring is changed depending on the displacement of the spool member. Since the spring constant of the spring member is changed whenever the spool member is moved, a resonance frequency of the spool member and the spring member is not fixed to a constant value. Therefore, outside oscillation energy is not collected in a spring system and thereby oscillation of the fluid pressure is suppressed. As a result, it is possible to provide a spool valve unit, according to which oscillation resisting property can be improved without preventing hydraulic control at high speed.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a schematic view including a cross-sectional view of a spool valve unit and showing a valve device using the spool valve unit according to a first embodiment of the present disclosure;

FIG. 2 is a graph showing a relationship between a displacement of a spool member and a biasing force of a spring member in the first embodiment;

FIG. 3 is a schematic view showing a spring-mass system;

FIG. 4 is a time chart showing an example of the displacement of the spool member;

FIG. 5 is a schematic view including a cross-sectional view of a spool valve unit and showing a valve device using the spool valve unit according to a second embodiment of the present disclosure;

FIG. 6 is a graph showing a relationship between the displacement of the spool member and the biasing force of the spring member in the second embodiment;

FIG. 7 is a schematic view including a cross-sectional view of a spool valve unit and showing a valve device using the spool valve unit according to a third embodiment of the present disclosure;

FIG. 8 is a graph showing a relationship between the displacement of the spool member and the biasing force of the spring member in the third embodiment;

FIG. 9 is a schematic view including a cross-sectional view of a spool valve unit and showing a valve device using the spool valve unit according to a fourth embodiment of the present disclosure;

FIG. 10 is a schematically enlarged side view showing a part of a sleeve member and a part of a spool member of the fourth embodiment, when viewed them in a direction of an arrow X in FIG. 9;

FIG. 11 is a schematic side view showing a passage connecting portion formed in a wall of a cylindrical axial end of the spool member of FIG. 10;

FIG. 12 is a graph showing a relationship between the displacement of the spool member and a damping force of a damping chamber in the fourth embodiment;

FIG. 13 is a schematically enlarged side view showing a part of a sleeve member and a part of a spool member according to a fifth embodiment of the present disclosure;

FIG. 14 is a schematic side view showing a passage connecting portion formed in a wall of a cylindrical axial end of the spool member of FIG. 13;

FIG. 15 is a graph showing a relationship between the displacement of the spool member and a damping force of a damping chamber in the fifth embodiment;

FIG. 16 is a schematically enlarged side view showing a part of a sleeve member and a part of a spool member according to a sixth embodiment of the present disclosure;

FIG. 17 is a schematic side view showing a passage connecting portion formed in a wall of a cylindrical axial end of the spool member of FIG. 16;

FIG. 18 is a graph showing a relationship between the displacement of the spool member and a damping force of a damping chamber in the sixth embodiment;

FIG. 19 is a schematically enlarged side view showing a part of a sleeve member and a part of a spool member according to a seventh embodiment of the present disclosure;

FIG. 20 is a schematic side view showing a passage connecting portion formed in a wall of a cylindrical axial end of the spool member of FIG. 19;

FIG. 21 is a graph showing a relationship between the displacement of the spool member and a damping force of a damping chamber in the seventh embodiment;

FIG. 22 is a schematically enlarged side view showing a part of a sleeve member and a part of a spool member according to an eighth embodiment of the present disclosure;

FIG. 23 is a schematic side view showing a passage connecting portion formed in a wall of a cylindrical axial end of the spool member of FIG. 22;

FIG. 24 is a graph showing a relationship between the displacement of the spool member and a damping force of a damping chamber in the eighth embodiment;

FIG. 25 is a schematically enlarged side view showing a part of a sleeve member and a part of a spool member according to a ninth embodiment of the present disclosure;

FIG. 26 is a schematic side view showing a passage connecting portion formed in a wall of a cylindrical axial end of the spool member of FIG. 25;

FIG. 27 is a graph showing a relationship between the displacement of the spool member and a damping force of a damping chamber in the ninth embodiment;

FIG. 28 is a schematic view including a cross-sectional view of a spool valve unit and showing a valve device using the spool valve unit according to a tenth embodiment of the present disclosure;

FIG. 29 is a flowchart for explaining a process to be executed by an electronic control unit of FIG. 28;

FIG. 30 is a schematic cross-sectional view showing a spool valve unit according to a prior art;

FIG. 31 is a schematic view showing a spring-mass system of the prior art shown in FIG. 30;

FIG. 32 is a time chart showing an example of a displacement of a spool member of the prior art shown in FIG. 30;

FIG. 33 is a schematic cross-sectional view showing a spool valve unit according to another prior art;

FIG. 34 is a schematic view showing a spring-mass system of the prior art shown in FIG. 33; and

FIG. 35 is a time chart showing an example of a displacement of a spool member of the prior art shown in FIG. 33.

### DESCRIPTION

A structure of a spool valve unit of a prior art will be at first explained. In recent years, an automatic transmission apparatus has been developed in view of improving fuel consumption ratio for an automotive vehicle, wherein the automatic transmission apparatus has multi-stage speed-change gears and wherein an input shaft and an output shaft are frequently connected to each other or separated from each other. In such a transmission apparatus, there is a demand for quickly connecting the input shaft and the output shaft to each other, after they are separated from each other. In addition, there is a demand for controlling a difference of slipping rotation between the input shaft and the output shaft via a torque converter, to thereby improve a ride comfortability by suppressing impact of a gear change and to increase a product value of the automotive vehicle.

A multiple disc clutch is generally used as a device for connecting the input shaft and the output shaft with each other or releasing the connection between them. When the multiple disc clutch (which works as a friction member) is rapidly pushed, the impact by the gear change occurs. Then, a vehicle driver and a passenger may feel uncomfortable. Therefore, there is a demand to provide a spool valve unit for hydraulic control, according to which a pushing force for the multiple disc clutch can be rapidly and exactly controlled.

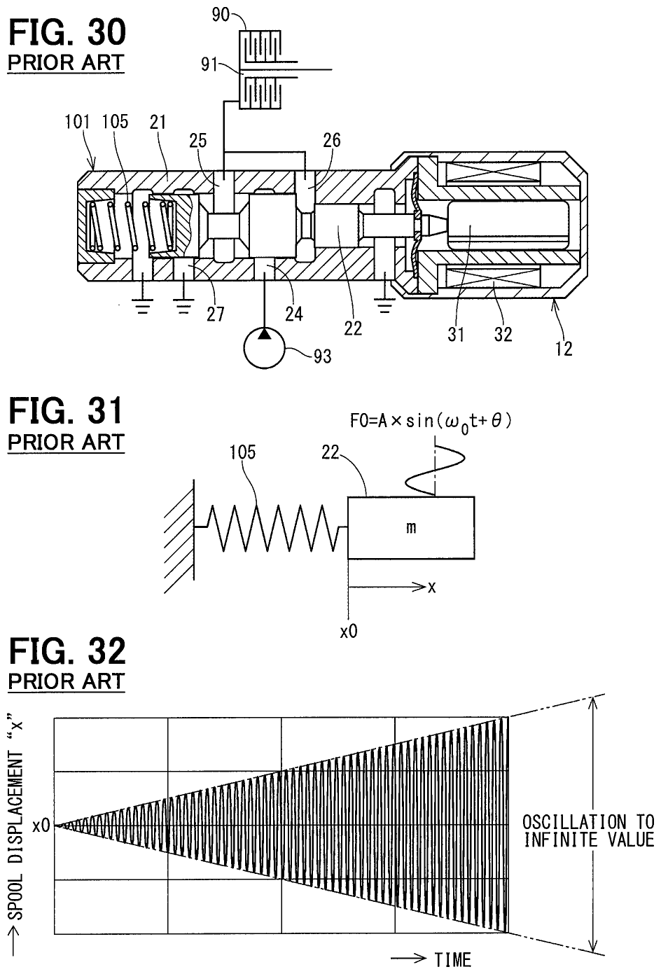

FIG. 30 shows a spool valve unit 101 of a prior art for the hydraulic control. In the spool valve unit 101, a spool member 22 is rapidly moved in an axial direction between a high-pressure port 24 and a low-pressure port 27 when a control force “F0” (FIG. 31) is applied to the spool member 22 in the axial direction (in a leftward direction), so that an intermediate fluid pressure between a pump pressure and a drain pressure is produced.

When the spool member 22 is reciprocated with a frequency, which includes a resonance frequency “ω0”, the spool member 22 and a linear spring member 105 resonate with each other and fluid pressure is thereby oscillated, as shown in FIG. 32.

Then, it becomes difficult to control a movement of the spool member 22. The resonance frequency “ω0” is calculated by a formula of “ω0=(k/m)^{0.5}”, wherein “k” is a spring constant of the spring member 105 and “m” is a mass of the spool member 22.

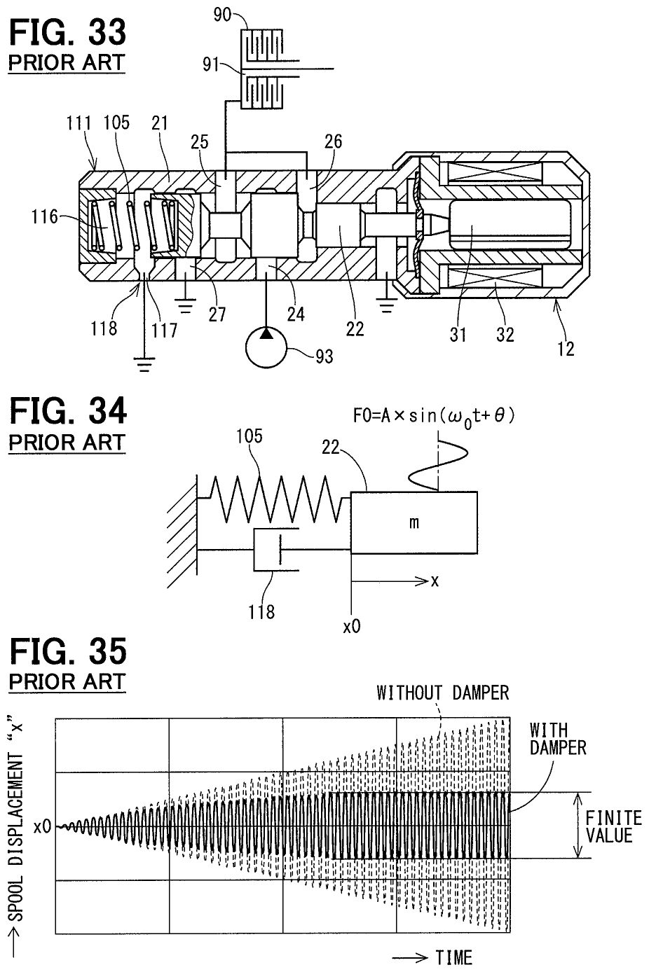

FIGS. 33 and 34 show a spool valve unit 111 of another prior art for the hydraulic control. An orifice 117 is provided in a fluid passage communicated to a spring chamber 116 to form a damping mechanism 118. The damping mechanism 118 is formed to suppress generation of the oscillation of the fluid pressure. As shown in FIG. 35, the displacement of the spool member 22 is suppressed to a finite value, when the damping mechanism 118 is formed. However, since the movement of the spool member 22 at high speed is limited by the damping mechanism 118 and thereby the control of the fluid pressure at the high speed is prevented, there is a barrier for improving response of the spool valve unit 111.

### DETAILED DESCRIPTION OF THE EMBODIMENTS

The present disclosure will be explained hereinafter by way of multiple embodiments and/or modifications with reference to the drawings. The same reference numerals are given to the same or similar structures and/or portions in order to avoid repeated explanation.

### First Embodiment

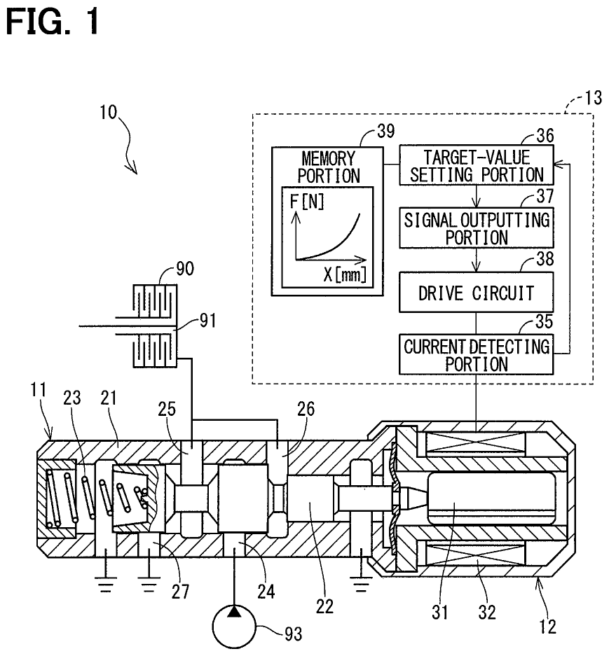

A spool valve unit 11 and a valve device 10 having the spool valve unit 11 are applied to an automatic transmission apparatus (not shown) for an automotive vehicle. As shown in FIG. 1, the valve device 10 controls fluid pressure for a multiple disc clutch 90 of the automatic transmission apparatus.

As shown in FIG. 1, the valve device 10 includes the spool valve unit 11, an electromagnetic unit 12 and an electronic control unit 13 (hereinafter, the ECU 13).

The spool valve unit 11 includes a sleeve member 21 of a cylindrical shape having multiple ports 24 to 27, a spool member 22, a spring member 23 for biasing the spool member 22 in an axial direction (a rightward direction in the embodiment; hereinafter also referred to as “a first axial direction”) of the sleeve member 21 and so on. The multiple ports 24 to 27 includes an inlet port 24 (also referred to as “a high-pressure port”) to which fluid (working oil) flows from an oil pump 93, an outlet port 25 connected to a clutch chamber 91 of the multiple disc clutch 90, a feedback port 26 to which a part of the working oil from the outlet port 25 flows, and a drain port 27 (also referred to as “a low-pressure port”) connected to a drain space.

The electromagnetic unit 12 includes a movable core 31 provided at an axial end of the spool member 22 (at a right-hand end of the spool member 22) and a solenoid 32 for generating electromagnetic force upon receiving electric power. The movable core 31 is moved by the electromagnetic force in the axial direction (in a leftward direction) to push the spool member 22 in the leftward direction. The electromagnetic force is changed depending on current to the solenoid 32.

When the spool member 22 is moved in the axial direction together with the movable core 31, a communication degree (a passage area) between the inlet port 24 and the outlet port 25 as well as a communication degree (a passage area) between the drain port 27 and the outlet port 25 is changed. A displacement (a moving amount) of the spool member 22 is decided by a balance between a biasing force of the spring member 23 and a sum of the electromagnetic force of the solenoid 32 and a feedback force by the working oil flowing from the outlet port 25 to the feedback port 26. The fluid pressure outputted from the outlet port 25 is thereby changed depending on the electromagnetic force.

The ECU 13 includes a current detecting portion 35 for detecting current flowing to the solenoid 32, a target-value setting portion 36 for setting a target current value, a signal outputting portion 37 for producing and outputting a driving signal so that a difference between the target current value and an actual current value becomes smaller, a drive circuit 38 for supplying a driving current with a predetermined current supply period depending on the driving signal, and so on. The ECU 13 controls the driving current to the solenoid 32 to move the spool member 22 and thereby to control the fluid pressure outputted from the spool valve unit 11.

A characterizing structure of the valve device 10 will be hereinafter explained. As shown in FIG. 1, the spring member 23 is composed of a non-linear coil spring, a diameter of which is not constant. A spring constant is not constant but changed depending on a displacement of the spring member 23 (that is, a displacement “x” of the spool member 22) in the axial direction.

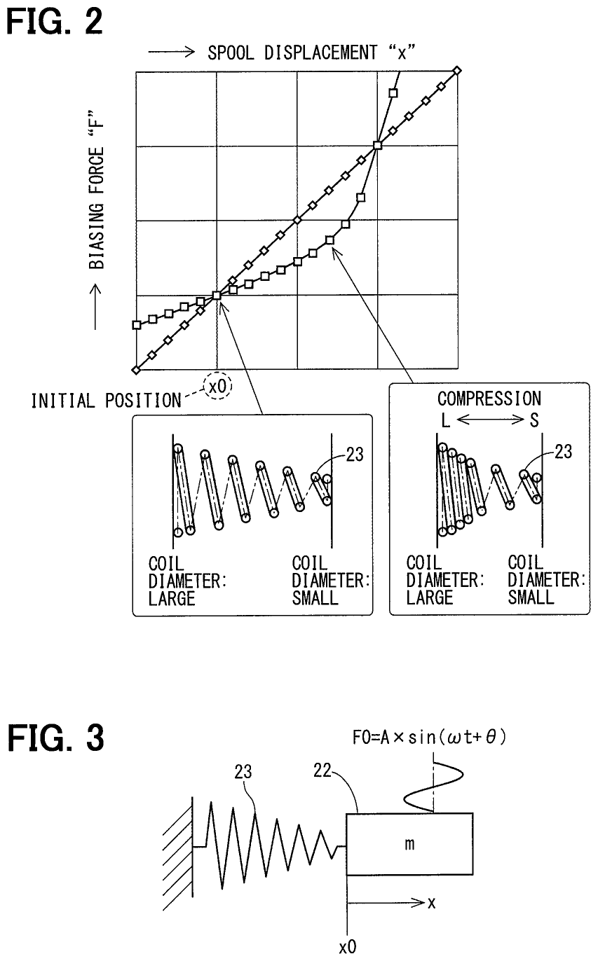

As shown in FIG. 2, a biasing force “F” of the spring member 23 is non-linearly changed depending on the displacement “x” of the spool member 22. Therefore, since the spring constant of the spring member 23 is changed each time when the spool member 22 is moved, a resonance frequency “ω0” of the spool member 22 and the spring member 23 is not fixed to a constant value. The resonance frequency “ω0” is calculated by a formula of “ω0=(k/m)^{0.5}”, wherein “k” is the spring constant of the spring member 23 and “m” is a mass of the spool member 22.

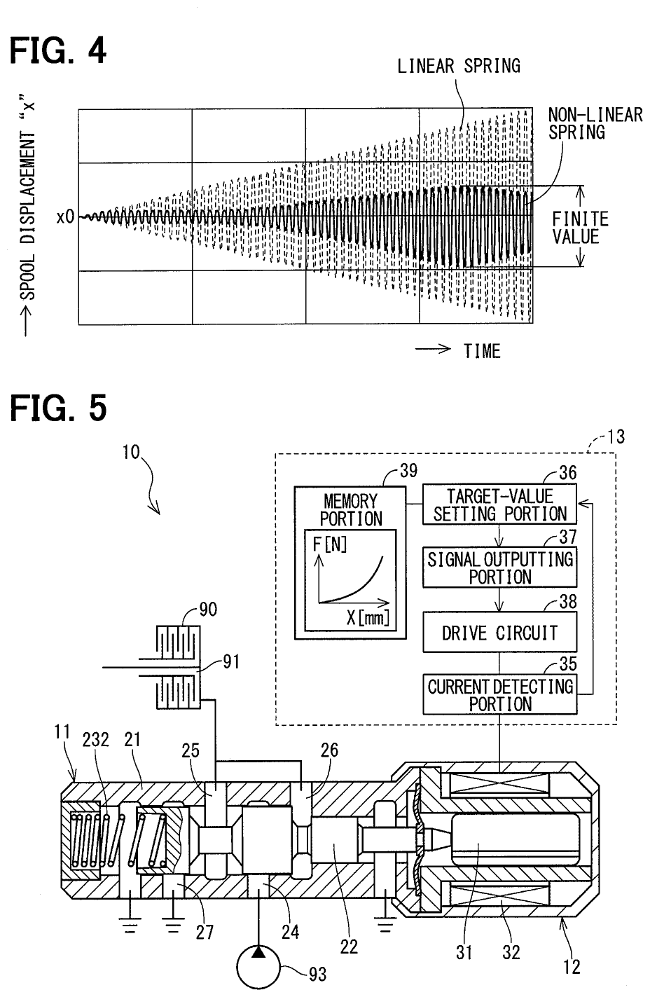

As shown in FIG. 3, when a control force “F0” is applied to the spool member 22 and the spool member 22 is reciprocated with a frequency “w”, which is equal to a resonance frequency “ω0” in a case of a predetermined displacement “x” of the spool member 22, energy of excitation oscillation is not collected in a spring mass system. As shown in FIG. 4, the displacement of the spool member 22 is limited to a finite value when the non-linear spring member 23 is used in the spool valve unit 11, so that oscillation of the fluid pressure can be suppressed.

As shown in FIG. 1, the ECU 13 includes a memory portion 39 for memorizing a relationship between the displacement “x” of the spool member 22 and the biasing force “F” of the spring member 23 as a characteristics map, to carry out the hydraulic control by use of the non-linear spring. The target-value setting portion 36 calculates the target current value for the solenoid 32 based on the characteristics map. More exactly, a target displacement is at first decided depending on a target fluid pressure to be outputted. Then, a target biasing force is calculated from the characteristics map depending on the target displacement. A target electromagnetic force is calculated depending on the target biasing force. The target current value is then calculated depending on the target electromagnetic force. The target current value may be more exactly calculated by use of, for example, a multiple-degree interpolation method. The target current value is transmitted to the signal outputting portion 37 and the drive circuit 38 supplies the electric power to the solenoid 32, so that the spool member 22 is properly moved to control the fluid pressure to be outputted from the spool valve unit 11 to the multiple disc clutch 90.

### Advantages

According to the spool valve unit 11 of the first embodiment, the spool member 22 is moved at high speed between the inlet port 24 (the high-pressure port) and the drain port 27 (the low-pressure port) to produce the intermediate fluid pressure, when the electromagnetic force is applied to the spool member 22 in the axial direction (in the leftward direction). The output fluid pressure from the spool valve unit 11 to the multiple disc clutch 90 is thereby controlled. The spring member 23 is composed of the non-linear coil spring, so that the spring biasing force “F” is non-linearly changed depending on the displacement “x” of the spool member 22.

The spring constant of the non-linear spring member 23 is changed depending on the displacement of the spring member 23. Since the spring constant is changed each time when the spool member 22 is moved, the resonance frequency “ω0” of the spool member 22 and the spring member 23 is not fixed to the constant value. As a result, the energy of the excitation oscillation is not collected in the spring mass system and the oscillation of the fluid pressure can be suppressed. In addition, the oscillation of the fluid pressure can be suppressed without providing a damping mechanism. It is, therefore, possible to provide the spool valve unit 11, which can increase fluid-oscillation protection without decreasing the hydraulic control at the high speed.

In the present embodiment, the ECU 13 memorizes the relationship between the displacement “x” of the spool member 22 and the biasing force “F” of the spring member 23 as the characteristics map and calculates the target current value for the solenoid 23 based on the characteristics map. The target current value calculated based on the characteristics map is transmitted to the signal outputting portion 37 and the drive circuit 38 supplies the electric power to the solenoid 32 depending on the drive signal from the signal outputting portion 37. As a result, the spool member 22 is correctly moved to control the fluid pressure of the working oil outputted from the spool valve unit 11 to the multiple disc clutch 90.

### Second Embodiment

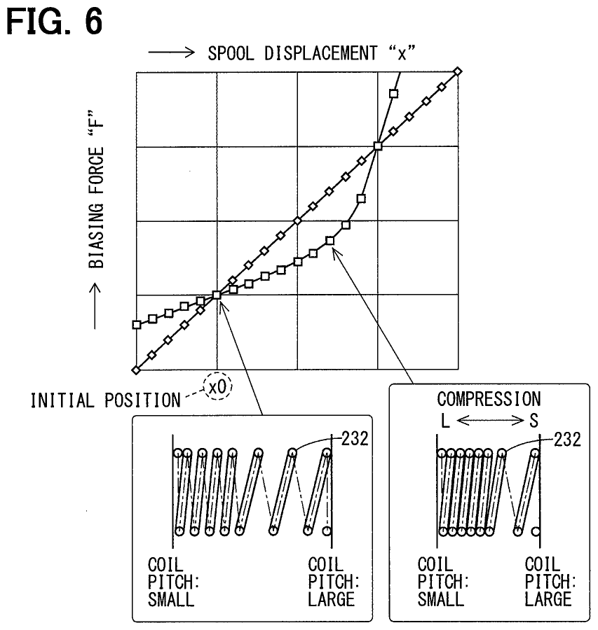

As shown in FIG. 5 showing a second embodiment, a spring member 232 is composed of a coil spring having an irregular coil pitch. As shown in FIG. 6, the biasing force “F” of the spring member 232 is non-linearly changed depending on the displacement “x” of the spool member 22. The spring member 232 having the irregular coil pitch can be also used in the present disclosure, so that the same advantages to those of the first embodiment can be obtained in the second embodiment.

### Third Embodiment

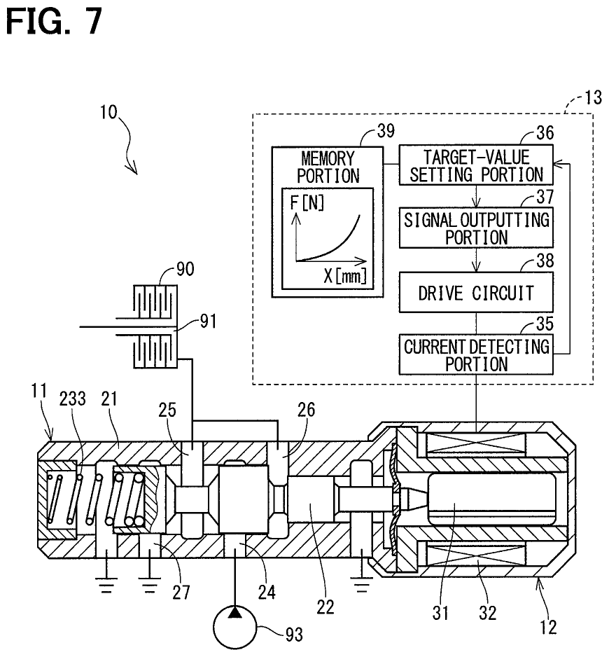

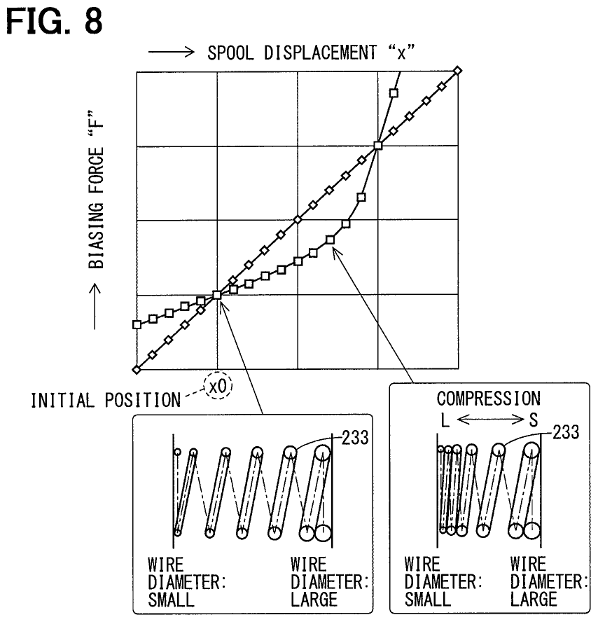

As shown in FIG. 7 showing a third embodiment, a spring member 233 is composed of a coil spring having an irregular wire diameter. As shown in FIG. 8, the biasing force “F” of the spring member 233 is non-linearly changed depending on the displacement “x” of the spool member 22. The spring member 232 having the irregular wire diameter can be also used in the present disclosure, so that the same advantages to those of the first embodiment can be obtained in the third embodiment.

In the above first to third embodiments, the non-linear spring member 23, 232 or 233 is used for biasing the spool member 22 in the first axial direction, so that the resonance frequency “ω0” of the spool member 22 and the spring member 23, 232 or 233 is not fixed to the constant value and thereby the oscillation of the fluid pressure is suppressed.

In the above embodiments, a range in which the oscillation of the fluid pressure may be generated is limited to a predetermined spool moving range (a specific spool-movement range), which is a part of a moving area of the spool member 22. The above point (limited to the specific spool-movement range) is not obtained in the spool valve unit of the prior art. In the following embodiments, the oscillation of the fluid pressure in the specific spool-movement range is suppressed, in addition that the oscillation of the fluid pressure is suppressed in the spool moving range other than the specific spool-movement range.

### Fourth Embodiment

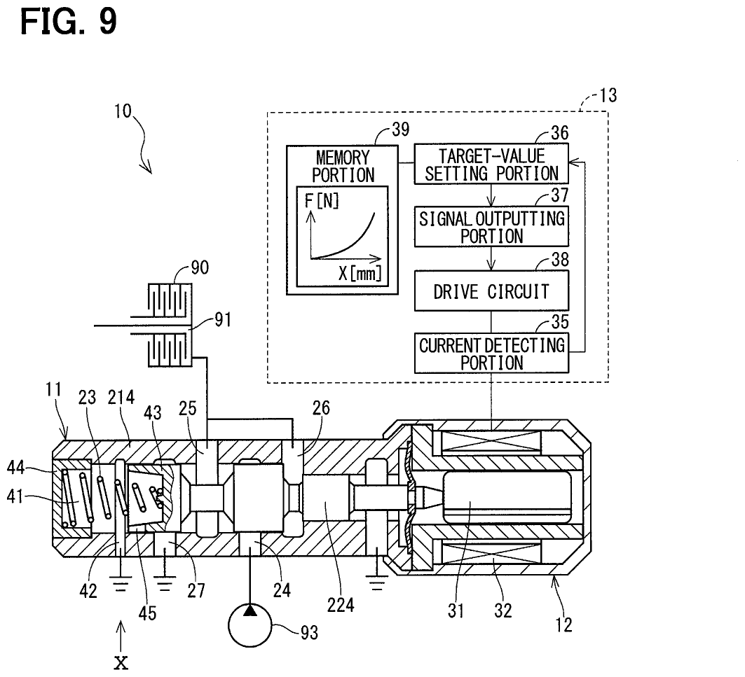

As shown in FIG. 9, a sleeve member 214 of a cylindrical shape has a damping chamber 41, a volume of which is changed when a spool member 224 is moved in the axial direction. The sleeve member 214 has a damper-side drain port 42 communicated to the damping chamber 41, which also works as a spring accommodation space for accommodating the spring member 23. The damping chamber 41 is defined by an inner peripheral surface of the sleeve member 214, a cylindrical axial end 43 of the spool member 224 (at a left-hand side of the spool member 224) and a plug member 44.

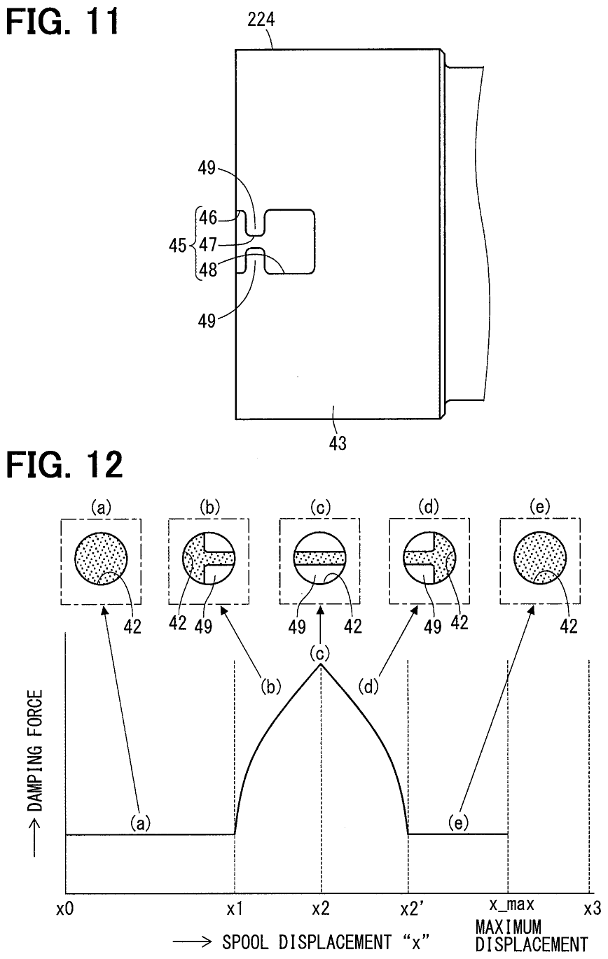

As shown in FIGS. 9 to 11, the spool member 224 has a passage connecting portion 45 for operatively connecting the damping chamber 41 to the damper-side drain port 42, in such a way that a passage area of the damper-side drain port 42 communicated to the damping chamber 41 via the passage connecting portion 45 is changed depending on the displacement of the spool member 224 in the axial direction. The passage area of the damper-side drain port 42 becomes smaller when the spool member 224 is moved to the specific spool-movement range.

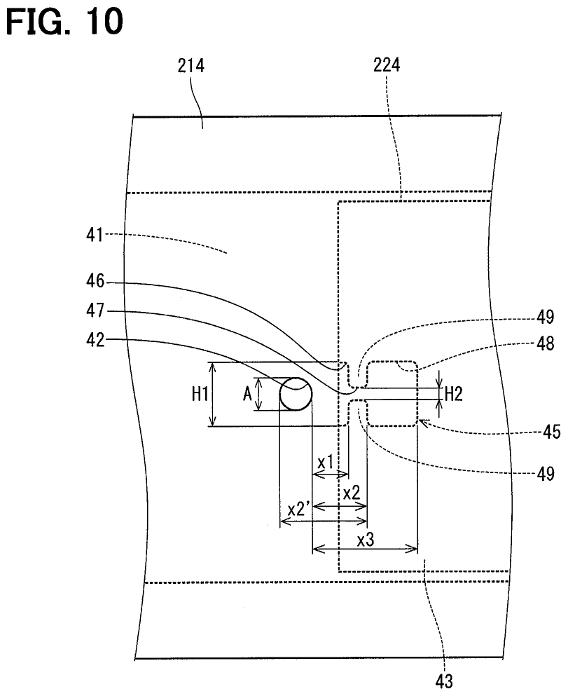

More exactly, as shown in FIGS. 10 to 12, the passage connecting portion 45 is a cut-out portion formed in a cylindrical wall of the cylindrical axial end 43 of the spool member 224. The cut-out portion (the passage connecting portion 45) includes a first opening portion 46 of a rectangular shape, a restricted portion 47 and a second opening portion 48 of a rectangular shape, wherein those portions 46, 47 and 48 are arranged in this order in the axial direction from a left-hand side of the spool member 224 to a right-hand side thereof. Each of the first and the second opening portions 46 and 48 has a width “H1” (a length in a circumferential direction of the spool member 224) larger than an inner diameter “A” of the damper-side drain port 42. The restricted portion 47 has a width “H2” (a length in the circumferential direction) smaller than the inner diameter “A” of the damper-side drain port 42. A part of the cylindrical wall of the cylindrical axial end 43 forms a pair of restriction wall portions 49, which are projected and opposed to each other in the circumferential direction of the cylindrical axial end 43. The restriction wall portions 49 operatively overlap with a part of the passage of the damper-side drain port 42, when the spool member 224 is moved to the specific spool-movement range.

In FIG. 10, “x1” is an axial distance between a right-hand end of the damper-side drain port 42 and a left-hand end of the restricted portion 47, when the spool member 224 is located at its initial position (a right-most position in FIG. 9). “x2” is an axial distance between the right-hand end of the damper-side drain port 42 and a right-hand end of the restricted portion 47 in the initial position of the spool member 224. “x2” is an axial distance between a left-hand end of the damper-side drain port 42 and the left-hand end of the restricted portion 47 in the initial position of the spool member 224. “x3” is an axial distance between the right-hand end of the damper-side drain port 42 and a right-hand end of the second opening portion 48 in the initial position of the spool member 224.

In addition, an axial length of the restricted portion 47 (that is, a difference between the axial distance “x1” and the axial distance “x2” (“x2−x1”)) is equal to the inner diameter “A” of the damper-side drain port 42. An axial length of the second opening portion 48 (that is, a difference between the axial distance “x3” and the axial distance “x2”, namely “x3−x2”) is made to be larger than the inner diameter “A” of the damper-side drain port 42.

In the present embodiment, the spool member 224 is movable in its operating range between a left-most position (equal to the initial position) of an initial displacement “x0” and a right-most position of a maximum displacement “x_max”. As shown in FIG. 12 (more exactly, in (a) or (e) of FIG. 12), when the damper-side drain port 42 is fully communicated to the damping chamber 41 through the first opening portion 46 or the second opening portion 48 in an operating range of the spool member 224 between the initial displacement “x0” and a displacement “x1” or in an operating range between a displacement “x2” and the maximum displacement “x_max”, a damping force of the damping chamber 41 is relatively small, so that the movement of the spool member 224 at the high speed is not prevented. On the other hand, when the damper-side drain port 42 is communicated to the damping chamber 41 partly or fully through the restricted portion 47, as shown in (b), (c) or (d) of FIG. 12, namely when the spool member 224 is moved to a position in an operating range between “x1” and “x2”, the damping force of the damping chamber 41 becomes larger depending on an overlapping position of the damper-side drain port 42 with the restricted portion 47. As a result, the oscillation of the fluid pressure in the specific spool-movement range (in the operating range between “x1” and “x2”) is effectively suppressed.

In FIG. 12, each of the displacements “x1”, “x2”, “x2” and “x3” corresponds to the respective axial distance “x1”, “x2”, “x2” or “x3” in FIG. 10.

### Advantages

In the present embodiment, the sleeve member 214 has the damping chamber 41 the volume of which is changed when the spool member 224 is moved in the axial direction, and the sleeve member 214 has the damper-side drain port 42 communicated to the damping chamber 41. The spool member 224 has the passage connecting portion 45 for operatively connecting the damping chamber 41 to the damper-side drain port 42. The passage area of the damper-side drain port 42 through the passage connecting portion 45 is changed depending on the displacement of the spool member 224. When the passage area of the damper-side drain port 42 through the passage connecting portion 45 is smaller, the damping chamber 41 and the damper-side drain port 42 can function as the damping mechanism, to thereby suppress the oscillation of the fluid pressure.

In the present embodiment, the passage area of the damper-side drain port 42 through the passage connecting portion 45 becomes smaller when the spool member 224 is moved to the specific spool-movement range (between “x1” and “x2”), which is a part of the full operating range of the spool member 224 (between “x0” and “x_max”) and in which the oscillation of the fluid pressure is likely to occur. Accordingly, the oscillation of the fluid pressure in the specific spool-movement range can be effectively suppressed. In other words, not only the response for the hydraulic control but also the fluid-oscillation protection can be increased.

In the present embodiment, the passage connecting portion 45 is composed of the cut-out portion formed in the cylindrical wall of the cylindrical axial end 43 of the spool member 224. The passage connecting portion 45 includes the first opening portion 46, the restricted portion 47 and the second opening portion 48, which are arranged in this order in the axial direction of the spool member 224 from the left-hand side to the right-hand side in the drawings. Each of the first and the second opening portions 46 and 48 has the width “H1” (the circumferential length) larger than the inner diameter “A” of the damper-side drain port 42. The restricted portion 47 has the width “H2” (the circumferential length) smaller than the inner diameter “A”. The restriction wall portions 49 are formed at both sides of the restricted portion 47 between the first and the second opening portions 46 and 48 in the axial direction and each of the restriction wall portions 49 extends in the circumferential direction of the spool member 224 to oppose to each other in the circumferential direction. The restriction wall portions 49 operatively close the part of the damper-side drain port 42, when the spool member 224 is moved in the specific spool-movement range. According to the above structure, it is possible to make the damping force of the damping chamber 41 larger, only when the spool member 224 is located at a resonant position of the non-linear spring member 23.

### Fifth Embodiment

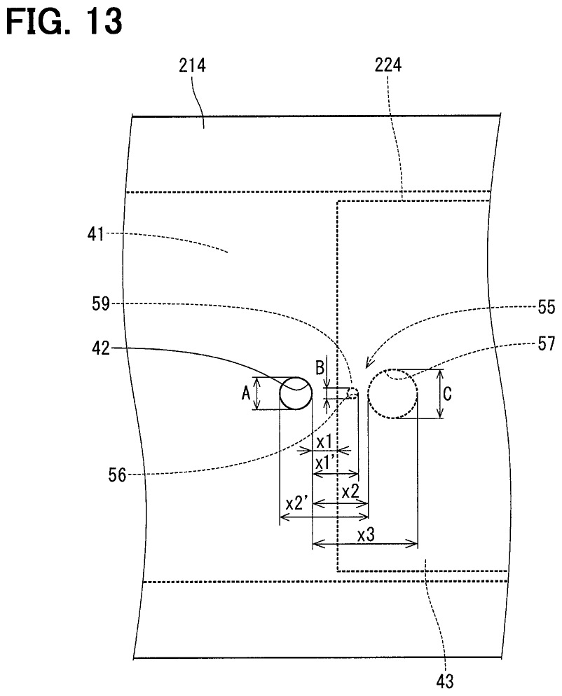

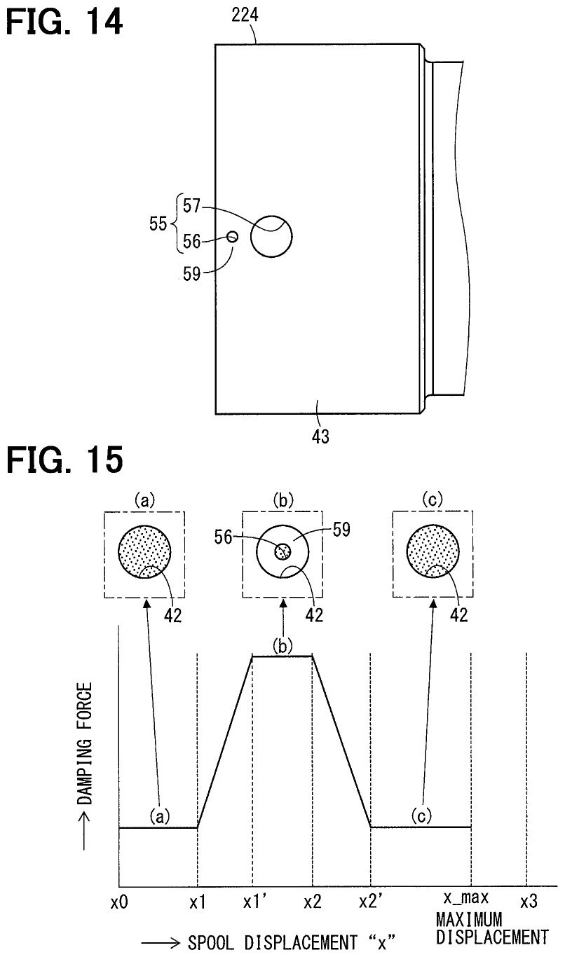

In a fifth embodiment shown in FIGS. 13 to 15, a passage connecting portion 55 is formed in the cylindrical wall of the cylindrical axial end 43 of the spool member 224 and the passage connecting portion 55 includes a small-diameter through-hole 56 and a large-diameter through-hole 57, which are arranged in this order in the axial direction of the spool member 224 from the left-hand side to the right-hand side in the drawings. The small-diameter through-hole 56 has an inner diameter “B” smaller than the inner diameter “A” of the damper-side drain port 42. The small-diameter through-hole 56 is operatively communicated to the damper-side drain port 42, when the spool member 224 is moved to a position within the specific spool-movement range (in a range between “x1” and “x2” in FIG. 15). The large-diameter through-hole 57 has an inner diameter “C” larger than the inner diameter “A” of the damper-side drain port 42. An axial distance between the small-diameter through-hole 56 and the large-diameter through-hole 57 in the axial direction is smaller than the inner diameter “A” of the damper-side drain port 42. A restriction wall portion 59, which is a part of the cylindrical axial end 43 adjacent to or surrounding the small-diameter through-hole 56, operatively closes a part of the damper-side drain port 42 when the spool member 224 is in the specific spool-movement range. An axial distance between a left-hand end of the cylindrical axial end 43 and a left-hand end of the small-diameter through-hole 56 is likewise smaller than the inner diameter “A” of the damper-side drain port 42.

In FIG. 13, “x1” is an axial distance between the right-hand end of the damper-side drain port 42 and the left-hand end of the cylindrical axial end 43, when the spool member 224 is located at its initial position (a right-most position in FIG. 13). “x1′” is an axial distance between the right-hand end of the damper-side drain port 42 and a right-hand end of the small-diameter through-hole 56 in the initial position of the spool member 224. “x2” is an axial distance between the right-hand end of the damper-side drain port 42 and a left-hand end of the large-diameter through-hole 57 in the initial position of the spool member 224. “x2” is an axial distance between a left-hand end of the damper-side drain port 42 and the left-hand end of the large-diameter through-hole 57 in the initial position of the spool member 224. “x3” is an axial distance between the right-hand end of the damper-side drain port 42 and a right-hand end of the large-diameter through-hole 57 in the initial position of the spool member 224.

As shown in (a) or (c) of FIG. 15, the damping force of the damping chamber 41 is relatively small, when the spool member 224 is located at a position between “x0” and “x1” or when the damper-side drain port 42 is fully communicated to the damping chamber 41 via the large-diameter through-hole 57 within a moving range of the spool member 224 between “x2” and “x_max”. As a result, the movement of the spool member 224 at the high speed is not prevented. On the other hand, the damping force of the damping chamber 41 becomes larger depending on a closed area of the damper-side drain port 42, when the restriction wall portion 59 partly closes the damper-side drain port 42 (in (b) of FIG. 15). As a result, the oscillation of the fluid pressure can be effectively suppressed when the spool member 224 is moved in the specific spool-movement range (in the spool moving range between “x1” and “x2”). As above, the same advantages to the fourth embodiment can be obtained in the present fifth embodiment.

### Sixth Embodiment

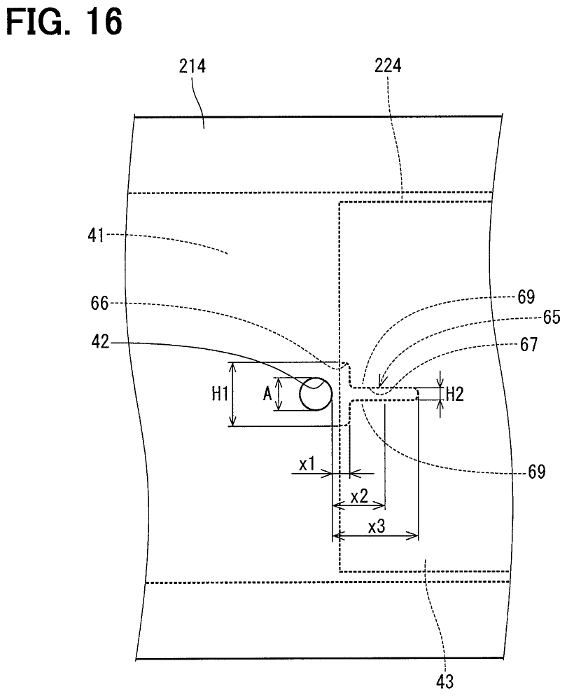

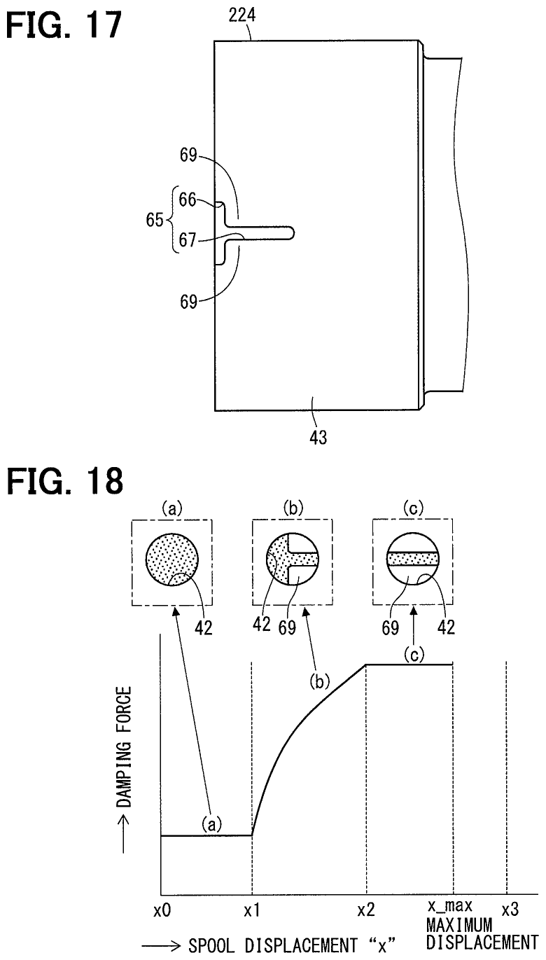

In a sixth embodiment shown in FIGS. 16 to 18, a passage connecting portion 65 is formed in the cylindrical wall of the cylindrical axial end 43 of the spool member 224. The passage connecting portion 65 is formed by a cut-out portion formed in the cylindrical axial end 43 and includes a wide opening portion 66 and a restricted portion 67, which are arranged in this order in the axial direction of the spool member 224 from the left-hand side to the right-hand side in the drawings. The wide opening portion 66 of a rectangular shape has a width “H1” (the circumferential length) larger than the inner diameter “A” of the damper-side drain port 42, while the restricted portion 67 of a rectangular shape has a width “H2” (the circumferential length) smaller than the inner diameter “A” of the damper-side drain port 42. The passage connecting portion 65 is operatively communicated to the damper-side drain port 42, when the spool member 224 is moved to the specific spool-movement range. Restriction wall portions 69 are formed at both sides of the restricted portion 67 in the circumferential direction of the spool member 224 and operatively close a part of the damper-side drain port 42, when the spool member 224 is moved to the specific spool-movement range.

In FIG. 16, “x1” is an axial distance between the right-hand end of the damper-side drain port 42 and a left-hand end of the restricted portion 67, when the spool member 224 is located at its initial position (at the right-most position in FIG. 16). “x2” is an axial distance between the right-hand end of the damper-side drain port 42 and an axial middle point of the restricted portion 67 in the initial position of the spool member 224. “x3” is an axial distance between the right-hand end of the damper-side drain port 42 and a right-hand end of the restricted portion 67 in the initial position of the spool member 224. In addition, each of axial distances of “x2−x1”, “x3−x2” and “x_max−x2” is larger than the inner diameter “A” of the damper-side drain port 42.

As shown in (a) of FIG. 18, the damping force of the damping chamber 41 is relatively small, when only the wide opening portion 66 is communicated to the damper-side drain port 42 within the moving range of the spool member 224 between “x0” and “x1”. As a result, the movement of the spool member 224 at the high speed is not prevented. On the other hand, the damping force of the damping chamber 41 becomes larger depending on a closed area of the damper-side drain port 42, when the restriction wall portions 69 partly close the damper-side drain port 42, as shown in (b) or (c) of FIG. 18. As a result, the oscillation of the fluid pressure can be effectively suppressed when the spool member 224 is moved in the specific spool-movement range. As above, the same advantages to the fourth embodiment can be also obtained in the present sixth embodiment.

### Seventh Embodiment

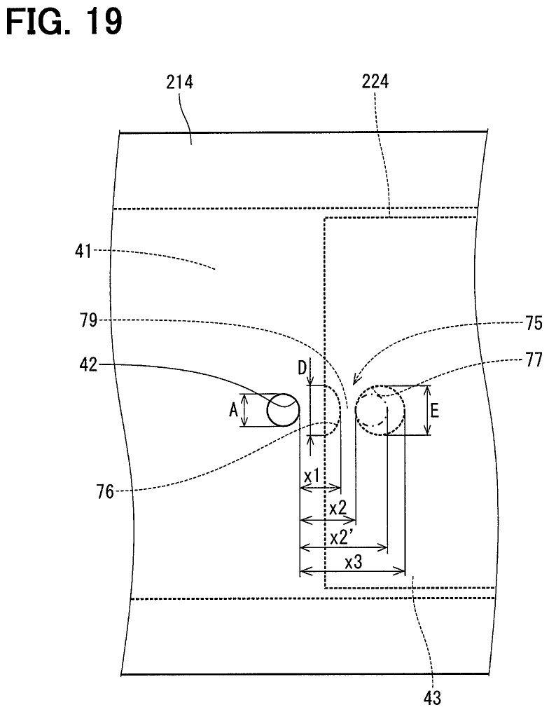

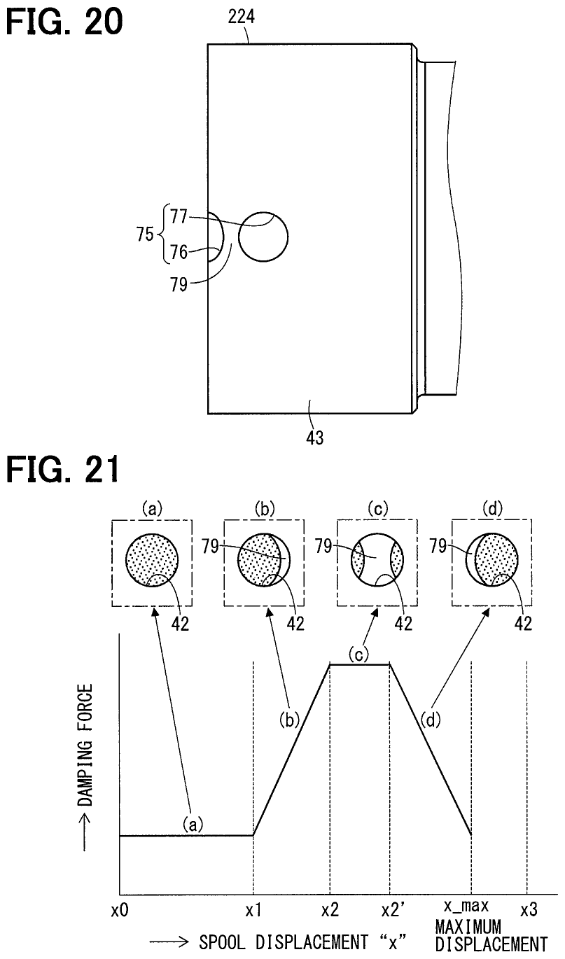

In a seventh embodiment shown in FIGS. 19 to 21, a passage connecting portion 75 is formed in the cylindrical wall of the cylindrical axial end 43 of the spool member 224. The passage connecting portion 75 includes a cut-out portion 76 of a half-circular shape and a large-diameter through-hole 77, which are arranged in this order in the axial direction of the spool member 224 from the left-hand side to the right-hand side in the drawings. The cut-out portion 76 has a width “D” (the circumferential length) larger than the inner diameter “A” of the damper-side drain port 42, while the large-diameter through-hole 77 has an inner diameter “E” larger than the inner diameter “A” of the damper-side drain port 42. An axial distance (x2−x1) between the cut-out portion 76 and the large-diameter through-hole 77 in the axial direction of the spool member 224 is smaller the inner diameter “A” of the damper-side drain port 42. A restriction wall portion 79 is formed between the cut-out portion 76 and the large-diameter through-hole 77 in the axial direction of the spool member 224 and operatively closes a part of the damper-side drain port 42, when the spool member 224 is moved to the specific spool-movement range.

In FIG. 19, “x1” is an axial distance between the right-hand end of the damper-side drain port 42 and a right-hand end of the cut-out portion 76, when the spool member 224 is located at its initial position (at the right-most position in FIG. 19). “x2” is an axial distance between the right-hand end of the damper-side drain port 42 and a left-hand end of the large-diameter through-hole 77 in the initial position of the spool member 224. “x2” is an axial distance between the right-hand end of the damper-side drain port 42 in the initial position of the spool member 224 and a position of the right-hand end of the damper-side drain port 42 when the spool member 224 is moved to such a spool position at which a left-hand end of the damper-side drain port 42 coincides with the right-hand end of the cut-out portion 76. “x3” is an axial distance between the right-hand end of the damper-side drain port 42 and a right-hand end of the large-diameter through-hole 77 in the initial position of the spool member 224.

As shown in (a) of FIG. 21, the damping force of the damping chamber 41 is relatively small, when the damper-side drain port 42 is fully communicated to the damping chamber 41 through the cut-out portion 76 within the moving range of the spool member 224 between “x0” and “x1”. As a result, the movement of the spool member 224 at the high speed is not prevented. On the other hand, the damping force of the damping chamber 41 becomes larger depending on the closed area of the damper-side drain port 42, when the restriction wall portion 79 partly closes the damper-side drain port 42, as shown in (b) to (d) of FIG. 21. As a result, the oscillation of the fluid pressure can be effectively suppressed when the spool member 224 is moved in the specific spool-movement range. As above, the same advantages to the fourth embodiment can be also obtained in the present seventh embodiment.

### Eighth Embodiment

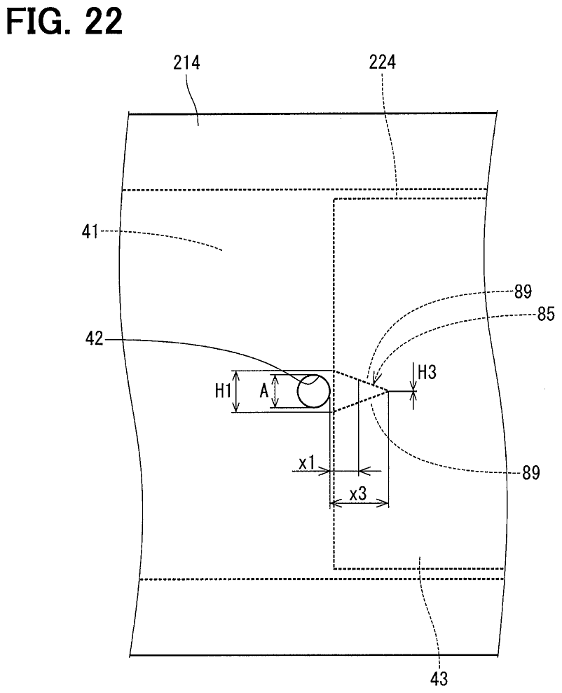

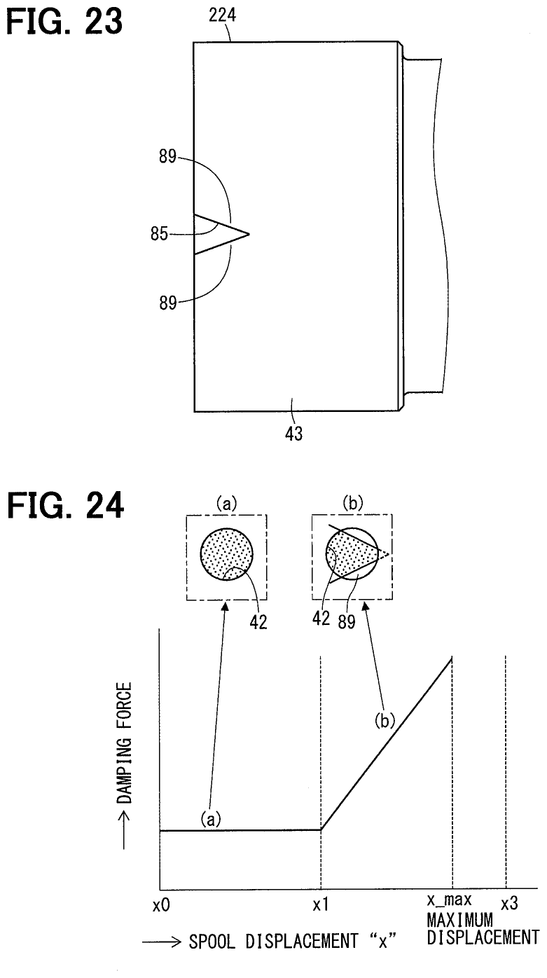

In an eighth embodiment shown in FIGS. 22 to 24, a passage connecting portion 85 is formed in the cylindrical wall of the cylindrical axial end 43 of the spool member 224. The passage connecting portion 85 is formed by a cut-out portion of a triangular shape, a circumferential width of which is gradually decreased in the axial direction from the left-hand side to the right-hand side in the drawings. An axial-end opening portion (a left-hand end) of the passage connecting portion 85 has a width “H1” in the circumferential direction larger than the inner diameter “A” of the damper-side drain port 42. A width of the passage connecting portion 85 at its right-hand end is “H3”, which is smaller than the inner diameter “A” of the damper-side drain port 42. A forward-side portion of the passage connecting portion 85 of the right-hand side is operatively communicated to the damper-side drain port 42 when the spool member 224 is moved to the specific spool-movement range. Restriction wall portions 89 formed at both circumferential sides of the passage connecting portion 85 operatively close a part of the damper-side drain port 42, when the spool member 224 is moved to the specific spool-movement range.

In FIG. 22, “x1” is an axial distance between the right-hand end of the damper-side drain port 42 in the initial position of the spool member 224 and the right-hand end of the damper-side drain port 42 when the spool member 224 is moved to a middle spool position at which each arc portion of the damper-side drain port 42 coincides with each side line of the triangular shape of the cut-out portion 85. “x3” is an axial distance between the right-hand end of the damper-side drain port 42 and the right-hand end of the passage connecting portion 85 in the initial position of the spool member 224.

As shown in (a) of FIG. 24, the damping force of the damping chamber 41 is relatively small, when the damping chamber 41 is fully communicated to the damper-side drain port 42 within the moving range of the spool member 224 between “x0” and “x1” via the axial-end opening portion (the left-hand portion) of the passage connecting portion 85. As a result, the movement of the spool member 224 at the high speed is not prevented. On the other hand, the damping force of the damping chamber 41 becomes larger depending on the closed area of the damper-side drain port 42, when the restriction wall portions 89 partly close the damper-side drain port 42, as shown in (b) of FIG. 24. As a result, the oscillation of the fluid pressure can be effectively suppressed when the spool member 224 is moved in the specific spool-movement range. As above, the same advantages to the fourth embodiment can be also obtained in the present eighth embodiment.

### Ninth Embodiment

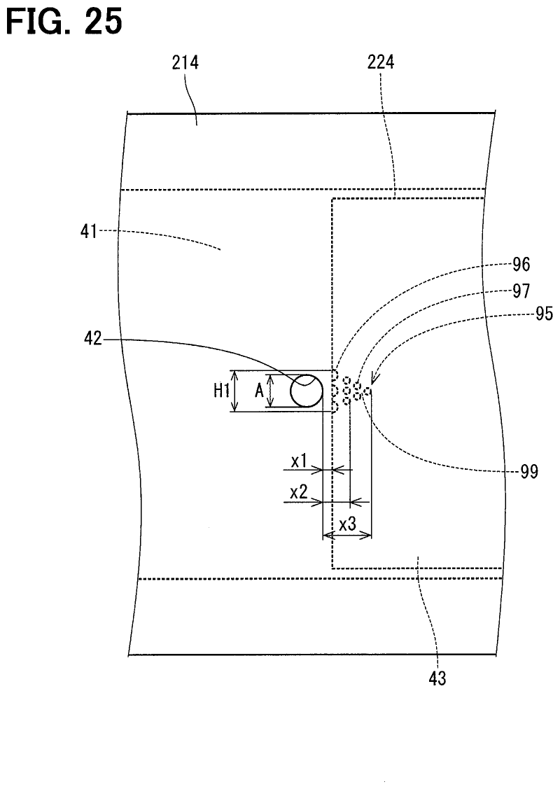

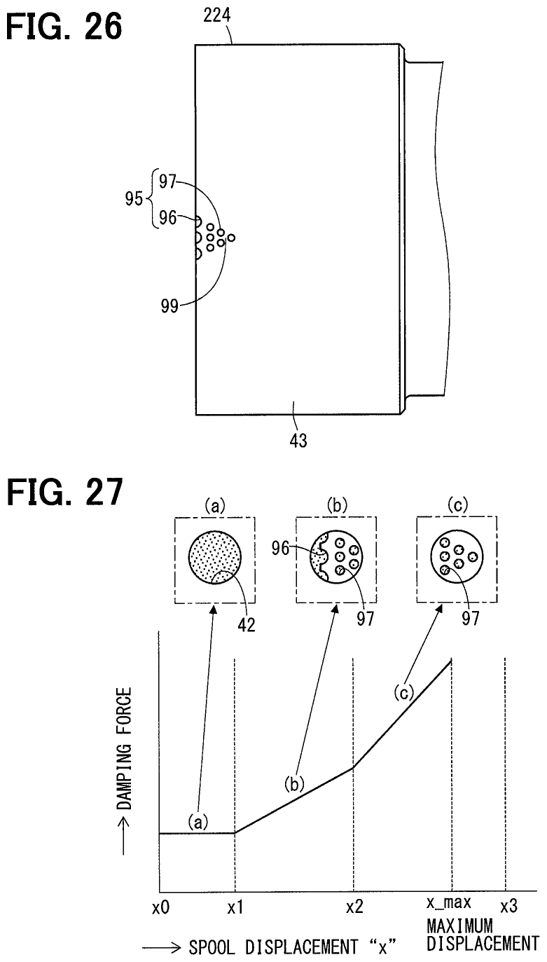

In a ninth embodiment shown in FIGS. 25 to 27, a passage connecting portion 95 is formed in the cylindrical wall of the cylindrical axial end 43 of the spool member 224. The passage connecting portion 95 is composed of multiple small cut-out portions 96 (each of which has a half-circular shape) and multiple small-diameter through-holes 97. Each of the small-diameter through-holes 97 has an inner diameter smaller than the inner diameter “A” of the damper-side drain port 42. Each distance between the small cut-out portion 96 and the small-diameter through-hole 97 in the axial and circumferential directions of the spool member 224 as well as each distance between the neighboring small-diameter through-holes 97 in the axial and circumferential directions of the spool member 224 is smaller than the inner diameter “A” of the damper-side drain port 42.

In the present embodiment, the small-diameter through-holes 97 are arranged in multiple rows each extending in the circumferential direction of the spool member 224 (in an up-down direction in the drawings). An inner diameter of the small-diameter through-hole 97 belonging to one of the rows (for example, a first row) of the left-hand side is larger than that of the small-diameter through-hole 97 belonging to another row (for example, a second row) located at a position of the right-hand side of the first row. In other words, the inner diameter of the small-diameter trough-hole gradually becomes smaller in the axial direction from the left-hand side to the right-hand side in the drawings.

A restriction wall portion 99, which is formed in an area surrounding the passage connecting portion 95, for example, an area among the neighboring cut-out portions 96 and/or neighboring small-diameter through-holes 97, operatively closes a part of the damper-side drain port 42, when the spool member 224 is moved to the specific spool-movement range.

In FIG. 25, “x1” is an axial distance between the right-hand end of the damper-side drain port 42 and the left-hand end of the cylindrical axial end 43, when the spool member 224 is located at its initial position (in the right-most position in FIG. 25). “x2” is an axial distance between the right-hand end of the damper-side drain port 42 and a right-hand end of each small-diameter through-hole 97 belonging to the first row, in the initial position of the spool member 224. “x3” is an axial distance between the right-hand end of the damper-side drain port 42 and a right-hand end of a right-most small-diameter through-hole 97, in the initial position of the spool member 224. In addition, the axial distance “x3” is larger than the inner diameter “A” of the damper-side drain port 42.

As shown in (a) of FIG. 27, the damping force of the damping chamber 41 is relatively small, when the restriction wall portion 99 does not close any part of the damper-side drain port 42. As a result, the movement of the spool member 224 at the high speed is not prevented. On the other hand, the damping force of the damping chamber 41 becomes larger depending on the closed area of the damper-side drain port 42, when the restriction wall portion 99 partly closes the damper-side drain port 42 (as indicated in (b) or (c) of FIG. 27). As a result, the oscillation of the fluid pressure can be effectively suppressed when the spool member 224 is moved in the specific spool-movement range. As above, the same advantages to the fourth embodiment can be also obtained in the present ninth embodiment.

### Tenth Embodiment

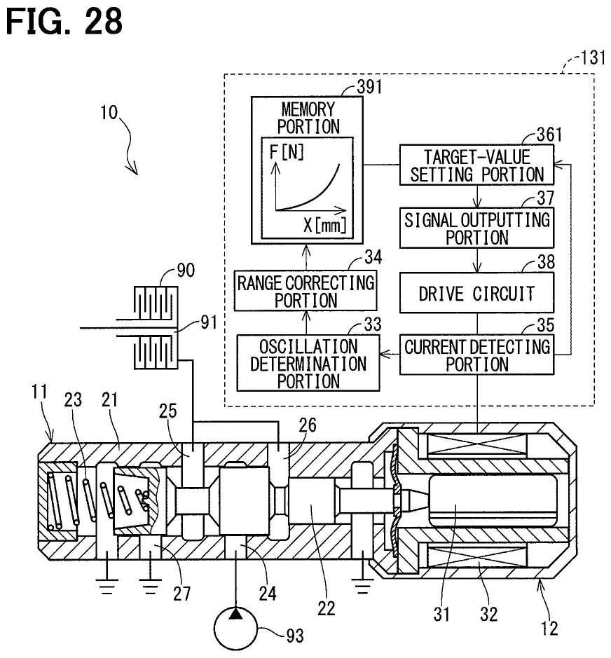

In a tenth embodiment shown in FIG. 28, an electronic control unit 131 (the ECU 131) includes the current detecting portion 35, the signal outputting portion 37, the drive circuit 38, a memory portion 391, a target-value setting portion 361, an oscillation determination portion 33, a range correcting portion 34 and so on. In a similar manner to the target-value setting portion 36 of the first embodiment, the target-value setting portion 361 of the present embodiment calculates the target current value for the solenoid 32 based on the characteristics map memorized in the memory portion 391.

In the present embodiment, a dither amplitude is applied to the target current, so that the current to the solenoid 32 is periodically changed with a dither cycle which is longer than the current supply cycle for the solenoid 32. Accordingly, the spool member 22 is moved in a micro oscillation mode to thereby suppress occurrence of hysteresis property, which may be caused by static friction of the spool member 22.

The memory portion 391 memorizes a spool moving range of the spool member 22, in which the oscillation of the fluid pressure is likely to occur, as the specific spool-movement range. The specific spool-movement range is calculated in advance based on a relationship between the displacement of the spool member 22 and the spring constant of the spring member 23 and such a calculated spool moving range is memorized in the memory portion 391.

The target-value setting portion 361 changes the dither cycle for the target current, when the spool member 22 is in the specific spool-movement range. More exactly, the dither cycle is changed to become larger than that of the case in which the spool member 22 is located at a position outside of the specific spool-movement range. It is thereby possible to avoid a dither frequency, which may generate the oscillation of the fluid pressure.

The present embodiment can be modified in various manners. For example, instead of changing the dither cycle, the dither amplitude may be changed or a phase of a waveform of the target current may be reversed. In the case that the dither amplitude is changed, the dither amplitude is changed to become smaller than that of the case in which the spool member 22 is located at the position outside of the specific spool-movement range.

The oscillation determination portion 33 determines whether the oscillation of the fluid pressure is generated or not, when a current displacement of the spool member 22 is outside of the specific spool-movement range. In the present embodiment, the oscillation determination portion 33 determines whether or not the oscillation of the fluid pressure is generated based on the current to the solenoid 32, which is detected by the current detecting portion 35.

The range correcting portion 34 corrects the specific spool-movement range to be memorized in the memory portion 391 when the oscillation determination portion 33 determines that the oscillation of the fluid pressure is generated, in such a way that the current displacement of the spool member 22 is included in the specific spool-movement range.

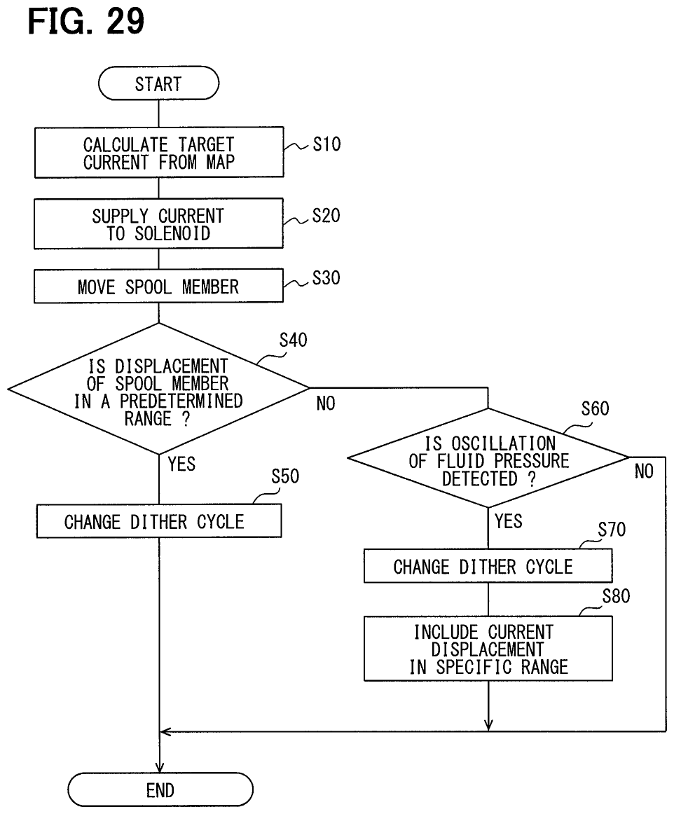

A process to be executed by the ECU 131 will be explained with reference to FIG. 29. The process of FIG. 29 is repeatedly executed when a command signal for moving the spool member 22 is outputted.

At a step S10, the ECU 131 (the target-value setting portion 361) calculates the target current for the solenoid 32 based on the characteristics map memorized in the memory portion 391. Then, the process goes to a step S20.

At the step S20, the electric power is supplied to the solenoid 32. At a step S30, the spool member 22 is operated to reciprocate. Then, the process goes to a step S40.

At the step S40, the ECU 131 determines whether the displacement of the spool member 22 is within the specific spool-movement range or not. When the displacement of the spool member 22 is in the specific spool-movement range (YES at the step S40), the process goes to a step S50. When the displacement of the spool member 22 is not in the specific spool-movement range (NO at the step S40), the process goes to a step S60.

At the step S50, the ECU 131 changes the dither cycle for the target current, to avoid the dither frequency which may generate the oscillation of the fluid pressure.

After the step S50, the process of FIG. 29 goes to an end.

At the step S60, the oscillation determination portion 33 determines whether the oscillation of the fluid pressure is generated or not, based on the current to the solenoid 32 detected by the current detecting portion 35. When the oscillation of the fluid pressure is generated (YES at the step S60), the process goes to a step S70. When the oscillation of the fluid pressure is not generated (NO at the step S60), the process of FIG. 29 goes to the end.

At the step S70, the dither cycle for the target current is changed to avoid the dither frequency which may generate the oscillation of the fluid pressure. After the step S70, the process of FIG. 29 goes to a step S80.

At the step S80, the ECU 131 (the range correcting portion 34) corrects the specific spool-movement range to be memorized in the memory portion 391 in such a way that the current displacement of the spool member 22 is included in the specific spool-movement range. After the step S80, the process of FIG. 29 goes to the end.

### Advantages

In the tenth embodiment, the memory portion 391 memorizes the predetermined spool moving range, in which the oscillation of the fluid pressure may easily occur, as the specific spool-movement range. The target-value setting portion 361 gives the dither cycle to the target current, so that the current to the solenoid 32 is periodically changed with the dither cycle which is longer than the power-supply cycle to the solenoid. In addition, the target-value setting portion 361 changes the dither cycle for the target current, when the displacement of the spool member 22 is in the specific spool-movement range. According to the above control, the oscillation frequency of the spool member is changed to a value different from the frequency which may cause the oscillation of the fluid pressure. The oscillation of the fluid pressure is thereby suppressed. The oscillation of the fluid pressure may be generated at a predetermined displacement of the spool member 22 when the non-linear spring member 23 is used. However, it is possible to avoid such oscillation of the fluid pressure by the above pin-point control. It is, therefore, possible to satisfy both of improving the response of the hydraulic control and the oscillation resisting property.

In addition, the ECU 131 includes the oscillation determination portion 33 for determining whether the oscillation of the fluid pressure is generated or not when the current displacement of the spool member 22 is outside of the specific spool-movement range. The ECU 131 further includes the range correcting portion 34 for changing the specific spool-movement range to be memorized in the memory portion 391 in such a way that the current displacement of the spool member 22 is included in the specific spool-movement range, when the oscillation determination portion 33 determines that the oscillation of the fluid pressure is generated. As above, it is possible to correct the specific spool-movement range.

### Modifications

A number of the spring member 23, 232 or 233 is not limited to one. Multiple spring members may be used. A non-linear spring member and a linear spring member may be combined to each other. Even in the case of one spring member, a part of the spring member may be made of a non-linear spring portion.

In the above embodiments, the damping chamber 41 is provided in a spring chamber for accommodating the spring member 23. However, the damping chamber 41 may be separately formed from the spring chamber.

The present disclosure is not limited to the above embodiments and/or modifications but can be further modified in various manners without departing from a spirit of the present disclosure.

What is claimed is:

1. A spool valve unit comprising:
a sleeve member having a high-pressure port and a low-pressure port;
a spool member movably accommodated in the sleeve member, so that the spool member is movable in an axial direction of the sleeve member; and
a spring member for biasing the spool member in a first axial direction,
wherein the spool member is moved in the axial direction at a high speed between the high-pressure port and the low-pressure port when a control force is applied to the spool member in a second axial direction opposite to the first axial direction, to produce and output an intermediate fluid pressure between a high pressure applied to the high-pressure port and a low pressure applied to the low-pressure port, and
wherein the spring member is composed of a non-linear spring, a biasing force of which is non-linearly changed with respect to a displacement of the spool member in the axial direction.

2. The spool valve unit according to claim 1, wherein
the spring member is composed of a non-linear coil spring, a coil diameter of which is not constant.

3. The spool valve unit according to claim 1, wherein
the spring member is composed of a non-linear coil spring having an irregular coil pitch.

4. The spool valve unit according to claim 1, wherein
the spring member is composed of a non-linear coil spring having an irregular coil wire diameter.

5. A valve device comprising;
the spool valve unit according to claim 1;
an electromagnetic unit having a solenoid and generating the control force to be applied to the spool member; and
an electronic control unit having;
a memory portion for memorizing a relationship between the displacement of the spool member and the biasing force of the spring member; and
a target-value setting portion for calculating a target current for the solenoid based on the relationship between the displacement of the spool member and the biasing force of the spring member.

6. The spool valve unit according to claim 1, wherein
the sleeve member has;
a damping chamber, a volume of which is changed when the spool member is moved in the axial direction, and
a damper-side drain port communicated to the damping chamber, and
the spool member has a passage connecting portion for operatively connecting the damping chamber to the damper-side drain port to change a passage area of the passage connecting portion between the damping chamber and the damper-side drain port depending on the displacement of the spool member.

7. The spool valve unit according to claim 6, wherein
the passage area of the passage connecting portion between the damping chamber and the damper-side drain port becomes smaller, when the spool member is moved to a position in a specific spool-movement range at which oscillation of fluid pressure is likely to occur.

8. The spool valve unit according to claim 7, wherein
the passage connecting portion is composed of a cut-out portion formed in a cylindrical wall of a cylindrical axial end of the spool member,
the passage connecting portion includes;
a first opening portion of a rectangular shape;
a restricted portion; and
a second opening portion of a rectangular shape,
wherein the first opening portion, the restricted portion and the second opening portion are arranged in this order in the first axial direction,
each of the first and the second opening portions has a width in a circumferential direction of the spool member, which is larger than an inner diameter of the damper-side drain port,
the restricted portion has a width in the circumferential direction, which is smaller than the inner diameter of the damper-side drain port, and
a part of the cylindrical axial end is formed as a restriction wall portion at a position on a side of the restricted portion in the circumferential direction, wherein the restriction wall portion operatively closes a part of the damper-side drain port when the spool member is moved to the specific spool-movement range.

9. The spool valve unit according to claim 7, wherein
the passage connecting portion is formed in a cylindrical wall of a cylindrical axial end of the spool member,
the passage connecting portion includes a small-diameter through-hole and a large-diameter through-hole, which are arranged in this order in the first axial direction,
the small-diameter through-hole has an inner diameter smaller than an inner diameter of the damper-side drain port,
the large-diameter through-hole has an inner diameter larger than the inner diameter of the damper-side drain port,
a distance between the small-diameter through-hole and the large-diameter through-hole in the axial direction is smaller than the inner diameter of the damper-side drain port, and
a part of the cylindrical axial end is formed as a restriction wall portion at a position surrounding the small-diameter through-hole, wherein the restriction wall portion operatively closes a part of the damper-side drain port when the spool member is moved to the specific spool-movement range.

10. The spool valve unit according to claim 7, wherein
the passage connecting portion is composed of a cut-out portion formed in a cylindrical wall of a cylindrical axial end of the spool member,
the passage connecting portion includes a wide opening portion of a rectangular shape and a restricted portion, which are arranged in this order in the first axial direction,
the wide opening portion has a width in a circumferential direction of the spool member, which is larger than an inner diameter of the damper-side drain port,
the restricted portion has a width in the circumferential direction, which is smaller than the inner diameter of the damper-side drain port, and
a part of the cylindrical axial end is formed as a restriction wall portion at a position neighboring to the restricted portion in the circumferential direction, wherein the restriction wall portion operatively closes a part of the damper-side drain port when the spool member is moved to the specific spool-movement range.

11. The spool valve unit according to claim 7, wherein
the passage connecting portion is formed in a cylindrical wall of a cylindrical axial end of the spool member,
the passage connecting portion includes a cut-out portion of a half-circular shape and a large-diameter through-hole, which are arranged in this order in the first axial direction,
the cut-out portion has a width in a circumferential direction of the spool member, which is larger than an inner diameter of the damper-side drain port,
the large-diameter through-hole has an inner diameter, which is larger than the inner diameter of the damper-side drain port,
a distance between the cut-out portion and the large-diameter through-hole in the axial direction is smaller than the inner diameter of the damper-side drain port, and
a part of the cylindrical axial end is formed as a restriction wall portion at a position between the cut-out portion and the large-diameter through-hole, wherein the restriction wall portion operatively closes a part of the damper-side drain port when the spool member is moved to the specific spool-movement range.

12. The spool valve unit according to claim 7, wherein
the passage connecting portion is composed of a cut-out portion of a triangular shape formed in a cylindrical wall of a cylindrical axial end of the spool member,
a width of the cut-out portion in a circumferential direction of the spool member is decreased in the first axial direction,
the width of the cut-out portion at its open end of the axial direction is larger than an inner diameter of the damper-side drain port,
the width of the cut-out portion at its closed end of the axial direction is smaller than the inner diameter of the damper-side drain port, and
a part of the cylindrical axial end is formed as a restriction wall portion at a position on a side of the cut-out portion in the circumferential direction, wherein the restriction wall portion operatively closes a part of the damper-side drain port when the spool member is moved to the specific spool-movement range.

13. The spool valve unit according to claim 7, wherein
the passage connecting portion is composed of multiple through-holes formed in a cylindrical wall of a cylindrical axial end of the spool member,
each of the through-holes has an inner diameter smaller than an inner diameter of the damper-side drain port,
a distance between neighboring through-holes in the axial direction is smaller than the inner diameter of the damper-side drain port,
the inner diameter of each through-hole becomes smaller in the first axial direction, and
a part of the cylindrical axial end is formed as a restriction wall portion at a position between the neighboring through-holes, wherein the restriction wall portion operatively closes a part of the damper-side drain port when the spool member is moved to the specific spool-movement range.

14. The valve device according to claim 5, wherein
the memory portion memorizes a predetermined part of a spool moving range, in which oscillation of fluid pressure is likely to occur, as a specific spool-movement range,
the target-value setting portion gives a dither amplitude to a target current, so that current to the solenoid is periodically changed with a dither cycle, which is longer than a power supply cycle to the solenoid, and
the target-value setting portion carries out one of the following controls, when the displacement of the spool member is in the specific spool-movement range;
a change of the dither cycle of the target current;
a change of the dither amplitude; and
a reverse of a phase of a waveform for the target current.

15. The valve device according to claim 14, wherein
the memory portion memorizes a map, which shows a relationship between the displacement of the spool member for the target current and a spring constant of the spring member.

16. The valve device according to claim 14, wherein
the electronic control unit includes;
an oscillation determination portion for determining whether oscillation of fluid pressure is generated, when a current displacement of the spool member is outside of the specific spool-movement range; and
a range correcting portion for correcting the part of the spool moving range to be memorized as the specific spool-movement range in such a way that the current displacement of the spool member is included in the specific spool-movement range, when the oscillation determination portion determines that the oscillation of the fluid pressure is generated.
